(19) United States
(12) Patent Application Publication
(10) Pub. No.: US 2007/0141437 A1
(43) Pub. Date: Jun. 21, 2007

(54) Removing and installing a fuel cell stack

(76) Inventors: Thomas J. Siciliano, Albany, NY (US); James M. D'Aleo, Clifton Park, NY (US); Louis A. Dormond, Amsterdam, NY (US)

Correspondence Address: TROP PRUNER & HU, PC, 1616 S. VOSS ROAD, SUITE 750, HOUSTON, TX, 77057-2631, US

(21) Appl. No.: 11/311,915

(22) Filed: Dec. 19, 2005

(51) Int. Cl. H01M 8/02; H01M 2/08

(52) U.S. Cl. 429/38; 429/35; 429/13

(57) ABSTRACT

An assembly includes a fuel cell stack, a manifold and a mechanism to slidably guide the fuel cell stack to a position at which a connection can be formed between the stack and the manifold.

### BACKGROUND

The invention generally relates to removing and installing a fuel cell stack.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 60° Celsius (C.) to 70° temperature range. Another type employs a phosphoric-acid-based polybenziamidazole, PBI, membrane that operates in the 150° to 200° temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLS) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system, as the fuel cell system may include (as examples) a cooling subsystem, a cell voltage monitoring subsystem, a control subsystem, a power conditioning subsystem, etc. The particular design of each of these subsystems is a function of the application that the fuel cell system serves.

The fuel cell stack typically is installed on top of a manifold, a component of the fuel cell system that serves as the interface for the input and output reactant and coolant plenums of the fuel cell stack. A hinge may be used to connect the fuel cell stack to the manifold, as described in U.S. Pat. No. 6,541,148, entitled “Manifold System For A Fuel Cell Stack,” which issued on Apr. 1, 2003.

The fuel cell stack typically has a size and weight that requires at least two persons to install the stack onto the manifold, thereby increasing the cost and time associated with manufacturing the fuel cell system.

Thus, there is a continuing need for better ways to remove and install a fuel cell stack onto and from a manifold.

### SUMMARY

In an embodiment of the invention, an assembly includes a fuel cell stack, a manifold and a mechanism to slidably guide the fuel cell stack to a position at which a connection can be formed between the stack and the manifold.

In another embodiment of the invention, an assembly includes a fuel cell stack and a manifold. The fuel cell stack includes a protrusion, and the manifold includes a channel to receive the protrusion to slidably guide the fuel cell stack to a position at which a connection can be formed between the stack and the manifold.

In yet another embodiment of the invention, a technique that is usable with a fuel cell stack includes sliding a fuel cell stack along a track to install the fuel cell stack on a manifold.

Advantages and other features of the invention will become apparent from the following drawing, description and claims.

### BRIEF DESCRIPTION OF THE DRAWING

FIG. 1 is a perspective view of a fuel cell stack and a manifold according to an embodiment of the invention.

FIGS. 2 and 9 are top views of the manifold according to different embodiments of the invention.

FIG. 3 is an end view of the manifold according to an embodiment of the invention.

FIG. 4 is a bottom view of the fuel cell stack according to an embodiment of the invention.

FIG. 5 is a detailed side view of the fuel cell stack illustrating guide protrusions of the stack according to an embodiment of the invention.

FIG. 6 is an illustration of a cube-shaped guide protrusion according to an embodiment of the invention.

FIG. 7 is an perspective view of a disk-shaped guide protrusion according to an embodiment of the invention.

FIG. 8 is a cross-sectional view of a well formed in a guide channel of the manifold according to an embodiment of the invention.

### DETAILED DESCRIPTION

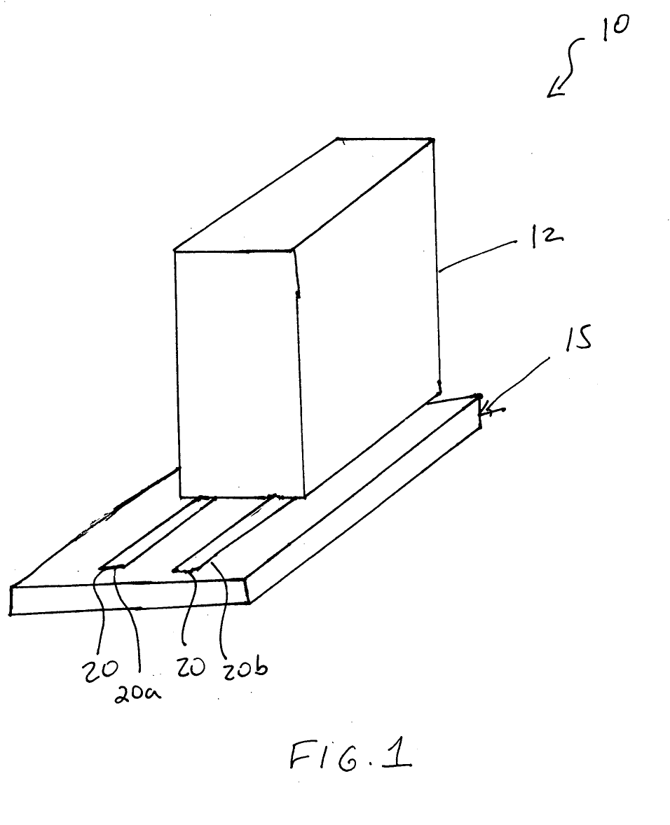

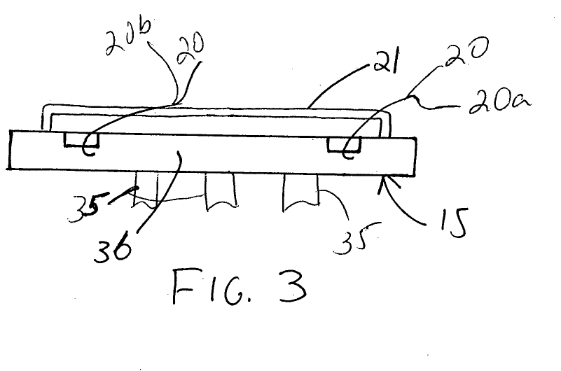

FIG. 1 depicts an exemplary and simplified view of an assembly 10 between a fuel cell stack 12 and a manifold 15. The manifold 15 serves as an interface to the stack's input and output plenums to connect the plenums to fuel, oxidant and coolant conduits 35 (three conduits being depicted in FIG. 3) of the fuel cell system 10. The simplified view of the fuel cell stack 12 and the manifold 15 is for purposes of illustrating a slide-type connection between the stack 12 and the manifold 15. In this regard, unlike conventional arrangements, a slide-based guide facilitates installation and removal of the fuel cell stack 12. More specifically, in accordance with some embodiments of the invention, the manifold 15 includes guide slots, or channels 20 (guide channels 20a and 20b being depicted as examples in FIG. 1), which receive guide protrusions (not shown in FIG. 1) that extend from the fuel cell stack 12 for purposes of guiding the stack 12 into the appropriate position for mounting the stack 12 to the manifold 15. Thus, the fuel cell stack 12 may be lifted by one person onto the guide channels 20 and then slid along the channels 20 into the appropriate position for mounting the manifold 15.

Although FIG. 1 depicts a guide assembly in which the guide channels 20 are formed in the manifold 15, it is noted that the guide channels 20 may likewise be formed in the fuel cell stack 12 in accordance with other embodiments of the invention. Its this alternative arrangement, the guide protrusions may alternatively extend upwardly from the manifold 15 into the guide channels of the fuel cell stack. Thus, many variations are possible and are within the scope of the appended claims.

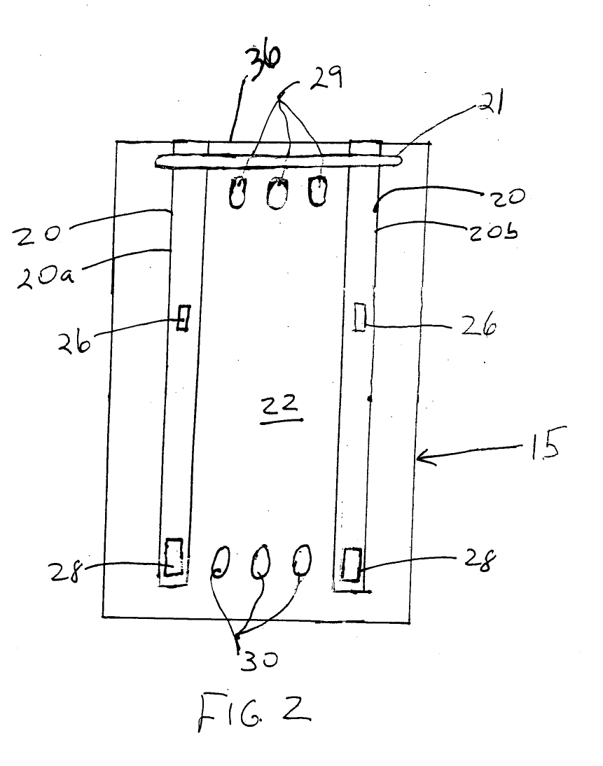

FIG. 2 depicts a top view of the manifold 15 in accordance with an embodiment of the invention. The guide channels 20 are sufficiently shallow to elevate the bottom surface of the fuel cell stack above a top surface 22 of the manifold 15. This elevated arrangement protects seals (gaskets, for example) that are mounted to the bottom of the fuel cell stack 12 from contacting the manifold 15 until the fuel cell stack 12 is in position to be mounted to the manifold 15.

When the fuel cell stack 12 is into position to be mounted to the manifold 15, the manifold openings of the fuel cell stack 12 align with sets 29 and 30 of manifold openings that are exposed on the top surface 22 of the manifold 15. When in this appropriate position, the guide protrusions from the fuel cell stack 12 are received into wells 26 and 28, which are formed in the guide channels 20.

The wells 26 and 28 are recessed regions of the guide channels 20 so that when the wells 26 and 28 receive the guide protrusions, the bottom surface of the fuel cell stack 12 is lowered onto the top surface 22 of the manifold 15. In this lowered position, the seals on the bottom of the fuel cell stack 12 are compressed between the stack 12 and the manifold 15 to seal the manifold openings of the stack 12 to the corresponding openings of the manifold 15.

As depicted in FIG. 2, in accordance with some embodiments of the invention, each guide channel 20 may have one well 26 and one well 28. The wells 26 and 28 may be differently-sized to accept correspondingly differently-sized protrusions from the fuel cell stack 12. More particularly, as depicted in FIG. 2, the wells 26 are located near the stack receiving end 36 of the manifold 15 and may be generally smaller in size (i.e., sized to receive a smaller guide protrusion) than the corresponding wells 28 located near the far end of the manifold 15. This arrangement permits correspondingly larger-sized guide protrusions on the front end of the fuel cell stack 12 to slide over the wells 26 (i.e., and not be received in the wells 26) so that when the stack 12 is in the appropriate position, the smaller guide protrusions are received in the wells 26 and the larger guide protrusions are received in the wells 28.

As also depicted in FIG. 2, in accordance with some embodiments of the invention, the manifold 15 includes a rail 21 that extends upwardly above the surface 22. As better depicted in FIG. 3, the rail 21 supports the back end of the fuel cell stack 12 as the fuel cell stack 12 slides down the guide rails 20. It is noted that the rail 21 may have a different form in other embodiments of the invention. For example, in some embodiments of the invention, the rail 21 may be U-shaped to allow the stack 10 to be lifted onto the rail 21 from the sides or rear of the manifold 15. The rail 21 keep the gaskets of the fuel cell stack from dragging across the top surface 22 of the manifold 15. If the gaskets were to drag on the manifold 15, the gaskets may be destroyed. When the stack 12 approaches its final position, the back end of the stack 12 clears the rail 21 just before the front protrusions of the stack 12 fall into the wells 28. This allows the stack 12 to drop straight down and rest on the gaskets that seal the stack 12 to the manifold 15.

In order to remove the fuel cell stack 12 from the manifold 15, the stack 12 maybe lifted by a certain vertical distance (approximately one inch, for example) and then pivoted on its front edge of its end plate, which allows the front and back guide protrusions to clear. At that point, the stack 12 begins to slide out in response to a pulling motion toward the front 36 of the manifold 15.

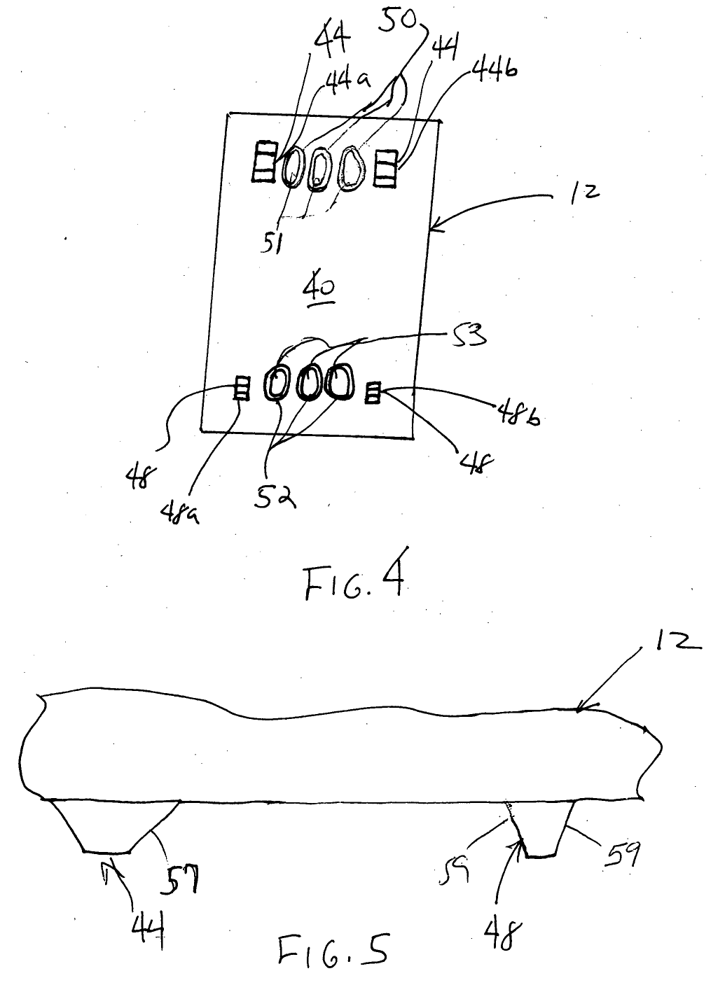

FIG. 4 depicts a bottom view of the fuel cell stack 12 in accordance with some embodiments of the invention. As depicted in FIG. 4, the fuel cell stack 12, near its front end, includes guide protrusions 48 (guide protrusions 48a and 48b, being depicted as examples) that extend outwardly from a bottom surface 40 of the fuel cell stack 12. The fuel cell stack 12 also includes larger guide protrusions 44 (guide protrusions 44a and 44b being depicted as examples) that also extend away from the bottom surface 40. The guide protrusions 48 are received in the smaller wells 28 and thus, are smaller in size than the guide protrusions 44. FIG. 4 also depicts manifold openings 50 that are lined with manifold openings 30 (see FIG. 2) of the manifold 15; and manifold openings 53 of the fuel cell stack 12 that are lined with corresponding manifold openings 29 (see FIG. 2) of the manifold 15. Additionally, in accordance with some embodiments of the invention, the fuel cell stack 12 includes gaskets 51 that are arranged around the openings 50 to form corresponding fluid seals; and the fuel cell stack 20 also includes gaskets 53 that are arranged around the openings 52 to likewise form corresponding fluid seals around these openings. In accordance with some embodiments of the invention, the radial protrusions 44 and 48 may be formed in the bottom end plate of the fuel cell stack 12. As a more specific example of the geometry of the guide protrusions 44 and 48, in accordance with some embodiments of the invention, the guide protrusions 44 and 48 may be generally rectangular in nature with sloping or beveled edges 57 and 59, respectively, as depicted in FIG. 5. The beveled edges 57 and 59 facilitate the removal and installation of the fuel cell stack 12 as the guide protrusions 44 and 48 are received into the wells 26 and 28, respectively.

It is noted that many other embodiments of the invention are possible and are within the scope of the appended claims. For example, FIG. 6 depicts a guide protrusion 60 in accordance with another embodiment of the invention. Unlike the guide protrusions 44 and 48, the guide protrusion 60 more closely resembles a rectangular solid.

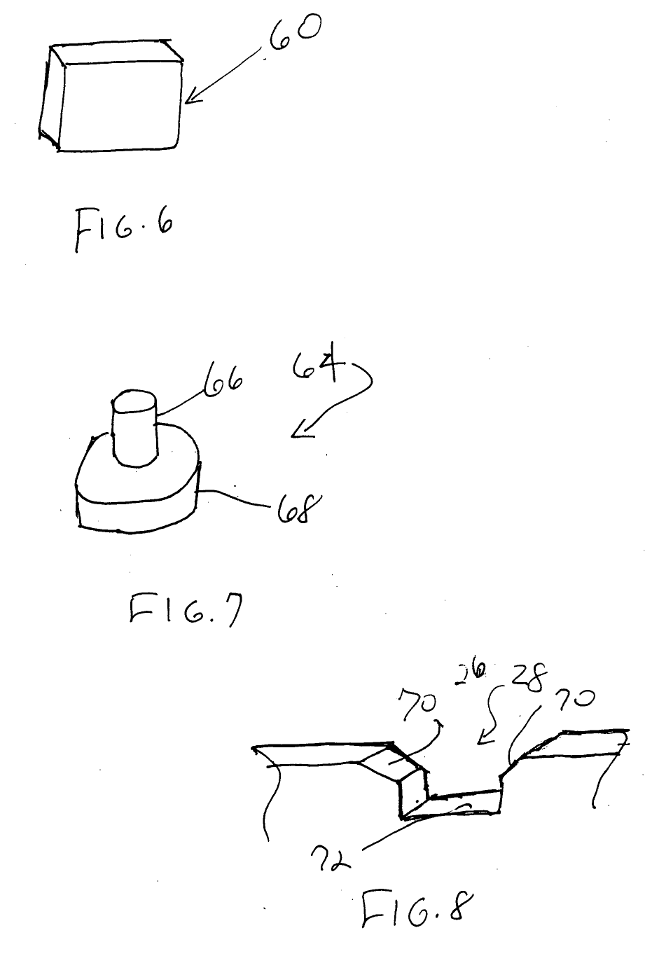

As yet another example, FIG. 7 depicts another possible guide protrusion 64 that includes a disk-shaped member 68 that is designed to slide in the guide rail 20. The guide protrusion 64 includes a spacer 66 that extends from the member 68 to elevate the fuel cell stack 12 above the top surface 22 of the manifold 15 (see FIG. 2, for example) as the stack 12 slides along the guide rails 20. For this embodiment of the invention, the fuel cell stack may have front and rear guide protrusions that are designed to be received in corresponding circular wells. that are disposed in the guide channels. For example, FIG. 9 depicts a manifold 100 that has a similar design to the manifold 15 with like reference numerals being used to depict similar components. Unlike the manifold 15, the manifold 100 has wells 104 (that replace the wells 26 of the manifold 15) and wells 106 (that replace the wells 28). The wells 104 and 106 are circular depressions that are located in the guide channels 20 to receive the guide protrusions 64 (see FIG. 7). Similar to the wells 26 and 28, the wells 104 are smaller in size (i.e., smaller in diameter) than the wells 106; and thus, the wells 104 receive smaller diameter guide protrusions 64 than the wells 106.

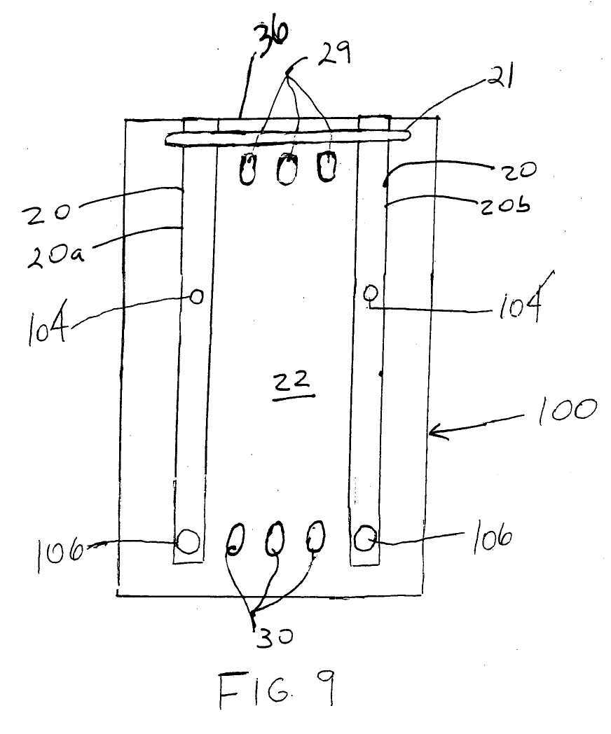

Many variations and designs of the wells 26 and 28 are possible and are within the scope of the appended claims. For example, FIG. 8 depicts an embodiment of the well 26, 28, in accordance with an embodiment of the invention. The well 26, 28 includes a recessed region 72 to receive the guide protrusion 44, 48. The side walls of the well 26, 28 may include, for example, sloped, or beveled surfaces 70, for purposes of facilitating the removal and installation of the fuel cell stack 12 onto the manifold 15.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. An assembly, comprising:
a fuel cell stack;
a manifold; and
a mechanism to slidably guide the fuel cell stack to a position at which a connection can be formed between the stack and the manifold.

2. The assembly of claim 1, wherein the mechanism comprises a channel formed in one of the fuel cell stack and the manifold.

3. The assembly of claim 2, wherein the mechanism comprises at least one protrusion formed in the other one of the fuel cell stack and the manifold, said at least one protrusion adapted to extend into the channel.

4. The assembly of claim 3, wherein said at least one protrusion comprises protrusion have different sizes.

5. The assembly of claim 3, wherein the channel comprises at least one well to receive said at least one protrusion.

6. The assembly of claim 3, wherein said at least one well have different sizes.

7. The assembly of claim 1, further comprising:
at least one sealing element to form a seal between the fuel cell stack and the manifold.

8. The assembly of claim 1, further comprising:
a rail to elevate the fuel cell stack above the manifold.

9. An assembly, comprising:
a fuel cell stack comprising a first protrusion; and
a manifold comprising a channel to receive the first protrusion to slidably guide the fuel cell stack to a position at which a connection can be formed between the stack and the manifold.

10. The assembly of claim 9, wherein the manifold further comprises a first well to receive the first protrusion in response to the fuel cell stack being in position for the connection with the manifold.

11. The assembly of claim 10, wherein the manifold further comprises a second well to receive another protrusion of the fuel cell stack, said second well having a different size than the first well.

12. A method usable with a fuel cell stack, comprising:
sliding a fuel cell stack along a track to install the stack on a manifold.

13. The method of claim 12, wherein the act of sliding comprises:
sliding the fuel cell stack along a track formed in one of the fuel cell stack and the manifold.

14. The method of claim 12, wherein the act of sliding comprises:
forming at least protrusion from one of the fuel cell stack and the manifold and receiving said at least protrusion into the track.

15. The method of claim 12, wherein the act of sliding comprises:
sliding the fuel cell stack along the track to a position in which the fuel cell stack is mounted to the manifold.

16. The method of claim 15, further comprising:
forming a feature in the track to stop the fuel cell stack at the position.

17. The method of claim 16, wherein the act of forming comprises:
forming a well in the track to receive a protrusion that slides along the track.
